(19) United States
(12) Patent Application Publication
(10) Pub. No.: US 2011/0209160 A1
(43) Pub. Date: Aug. 25, 2011

(54) Managed Code State Indicator

(76) Inventor: Vasanth Venkatachalam, Austin, TX (US)

(21) Appl. No.: 12/709,595

(22) Filed: Feb. 22, 2010

(51) Int. Cl. G06F 9/46; G06F 3/00; G06F 9/44; G06F 13/00

(52) U.S. Cl. 719/317; 719/328

(57) ABSTRACT

A system and method are disclosed for monitoring the state of a workload executing with a Java virtual machine (JVM). A state monitoring agent receives performance measurement data associated with the JVM executing the JVM workload. The state monitoring agent then processes the performance measurement data to determine when individual performance measurement data values have remained beneath a predetermined performance threshold value for a predetermined time period. If so, the state monitoring agent generates predetermined state data, which is then provided through an application program interface (API).

### BACKGROUND OF THE INVENTION

1. Field of the Invention

Embodiments of the invention relate generally to information processing systems. More specifically, embodiments of the invention provide a system and a method for monitoring the state of a workload executing with a virtual machine such as a Java Virtual Machine (JVM).

2. Description of the Related Art

Application virtual machines such as Java Virtual Machines are known in the art. Java is an object oriented programming language and environment that has gained wide acceptance in recent years. One aspect of Java is its portability, which has contributed to its popularity with developers of software applications. Java's approach to portability is to compile Java language code into Java bytecode, which is analogous to machine code, but is instead interpreted by a Java virtual machine (JVM) written specifically for the host computing platform. As a result, software applications written in Java can be written once, compiled once, and then run on any combination of hardware and operating system that supports a JVM.

A key concept in computer programming is the idea of a system's state, which is essentially a snapshot that measures various conditions in the system. The concept of state information extends to managed code, which is a workload that runs on a virtual machine, such as a JVM. It is often advantageous to know when the state of a Java workload reaches a predetermined state, such as a quiescent or “steady-state” that represents the workload's typical behavior. However, workloads aren't immediately in a steady-state when they begin running. For example, the rate of class loadings, just-in-time (JIT) compilations, and garbage collections will initially be higher in Java workloads because the JVM will be compiling methods that it has encountered for the first time. In addition, cache misses may be initially higher. These performance fluctuations do not represent the typical behavior of a workload, which cannot be accurately measured until the fluctuations end and the workload reaches a steady-state.

However, this steady-state information is generally hidden from the programmer. Current approaches to this issue include running a JVM with command line options that output event statistics, from which the state of the workload can be deduced. For example, a JVM can be run with verbose options that print every compilation and garbage collection. As these events decrease over time then it can be deduced that the Java workload has reached a steady-state. However, this approach is typically subjective and error-prone as compilations and garbage collections continue throughout the running of a Java workload. As such it is difficult to tell when the rates of these events are low enough for the Java workload to be in a steady-state, or conversely, when fluctuations in these rates cause the workload to diverge from its steady state. Furthermore, complex applications such as web server workloads can go through multiple phases, which would be impractical to measure manually. Moreover, verbose output can affect the performance of the Java workload. In view of the foregoing, there is a need for determining when a Java workload has reached a predetermined state, such as a steady-state, so that its typical performance can be accurately measured.

### SUMMARY OF EMBODIMENTS OF THE INVENTION

A system and method are disclosed for monitoring the state of a workload executing with a virtual machine. In various embodiments, source code, such as Java source code, is compiled by a compiler (e.g., a Java compiler) to produce bytecode (e.g., a Java bytecode). Java compilation operations are then begun by compiling the Java bytecode into a Java virtual machine (JVM) workload with a just-in-time (JIT) compiler.

In various embodiments, a state monitoring agent receives performance measurement data associated with the virtual machine executing the virtual machine workload. In these and other embodiments, the performance measurement data comprises class loading data, bytecode interpreter calls data, just-in-time compilation data, garbage collection data, and cache miss data. In various embodiments, the performance measurement data is provided to the state monitoring agent by one or more resource managers such as, for example Managed Beans (MBeans). The state monitoring agent then processes the performance measurement data to determine when individual performance measurement data values have remained beneath a predetermined performance threshold value for a predetermined time period. In various embodiments, the predetermined performance threshold value and the predetermined time period are configurable by a user.

Once the individual performance measurement data values remain beneath their corresponding predetermined performance threshold values for the predetermined time period, the state monitoring agent generates steady-state data. The steady-state data is then provided through an application program interface (API). In various embodiments, the (API) comprises a Java Managed Extensions (JMX) interface. In turn, the API provides the steady-state data to a workload performance measurement tool.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating an information processing system as implemented in accordance with an embodiment of the invention;

FIG. 2 is a simplified block diagram of a state monitoring agent, Managed Beans (MBeans), and a Java Management Extensions (JMX) interface as implemented in accordance with an embodiment of the invention;

FIG. 3 is a generalized flow chart of the operation of a state monitoring agent as implemented in accordance with an embodiment of the invention.

### DETAILED DESCRIPTION

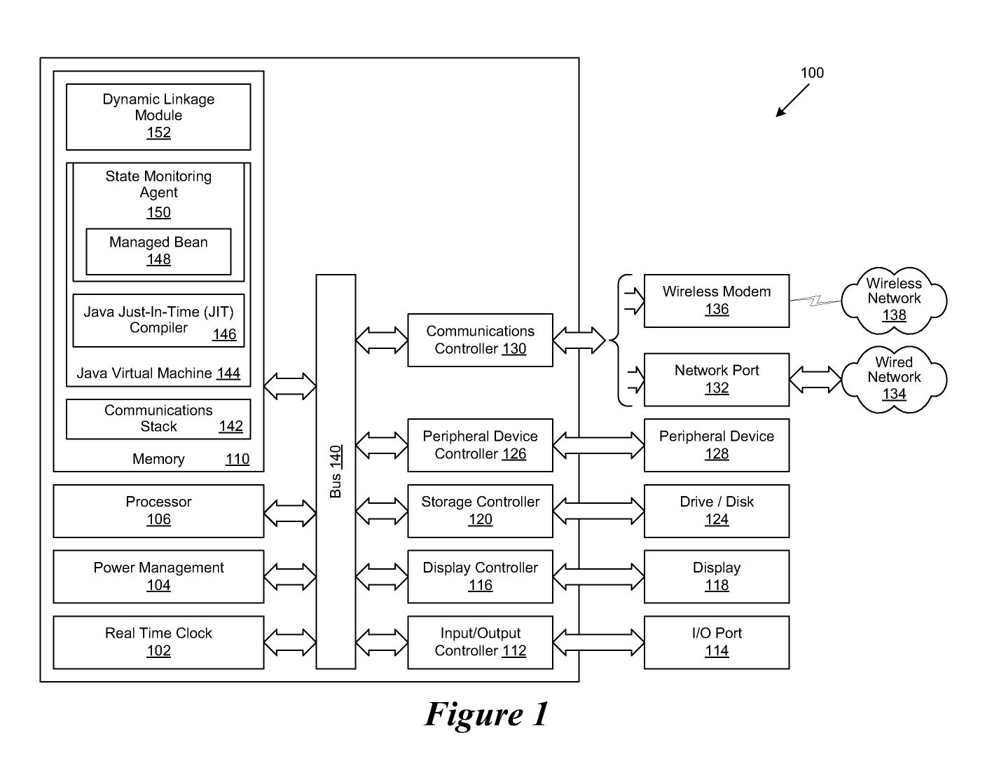

A system and method are disclosed for monitoring the state of a workload executing with a virtual machine. In the embodiments described herein, focus on JVM is made. However, other virtual machines could be adapted to embody aspects of the present invention. FIG. 1 is a generalized block diagram illustrating an information processing system 100 as implemented in accordance with an embodiment of the invention. System 100 comprises a real-time clock 102, a power management module 104, a processor 106 and memory 110, all physically coupled via bus 140. In various embodiments, memory 110 comprises volatile random access memory (RAM), non-volatile read-only memory (ROM), non-volatile flash memory, or any combination thereof. In one embodiment, memory 110 also comprises communications stack 142, Java Virtual Machine 144 and dynamic linkage module 152. The Java virtual machine 144 further comprises a just-in-time (JIT) compiler 146 and a state monitoring agent 150, which further comprises one or more Managed Beans (MBeans) 148.

Also physically coupled to bus 140 is an input/out (I/O) controller 112, further coupled to a plurality of I/O ports 114. In different embodiments, I/O port 114 may comprise a keyboard port, a mouse port, a parallel communications port, an RS-232 serial communications port, a gaming port, a universal serial bus (USB) port, an IEEE1394 (Firewire) port, or any combination thereof. Display controller 116 is likewise physically coupled to bus 140 and further coupled to display 118. In one embodiment, display 118 is separately coupled, such as a stand-alone, flat panel video monitor. In another embodiment, display 118 is directly coupled, such as a laptop computer screen, a tablet PC screen, or the screen of a personal digital assistant (PDA). Likewise physically coupled to bus 140 is storage controller 120 which is further coupled to mass storage devices such as a tape drive or hard disk 124. Peripheral device controller is also physically coupled to bus 140 and further coupled to peripheral device 128, such as a random array of independent disk (RAID) array or a storage area network (SAN).

In one embodiment, communications controller 130 is physically coupled to bus 140 and is further coupled to network port 132, which in turn couples the information processing system 100 to one or more physical networks 134, such as a local area network (LAN) based on the Ethernet standard. In other embodiments, network port 132 may comprise a digital subscriber line (DSL) modem, cable modem, or other broadband communications system operable to connect the information processing system 100 to network 134. In these embodiments, network 134 may comprise the public switched telephone network (PSTN), the public Internet, a corporate intranet, a virtual private network (VPN), or any combination of telecommunication technologies and protocols operable to establish a network connection for the exchange of information.

In another embodiment, communications controller 130 is likewise physically coupled to bus 140 and is further coupled to wireless modem 136, which in turn couples the information processing system 100 to one or more wireless networks 138. In one embodiment, wireless network 138 comprises a personal area network (PAN), based on technologies such as Bluetooth or Ultra Wideband (UWB). In another embodiment, wireless network 138 comprises a wireless local area network (WLAN), based on variations of the IEEE 802.11 specification, often referred to as WiFi. In yet another embodiment, wireless network 138 comprises a wireless wide area network (WWAN) based on an industry standard including two and a half generation (2.5G) wireless technologies such as global system for mobile communications (GPRS) and enhanced data rates for GSM evolution (EDGE). In other embodiments, wireless network 138 comprises WWANs based on existing third generation (3G) wireless technologies including universal mobile telecommunications system (UMTS) and wideband code division multiple access (W-CDMA). Other embodiments also comprise the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

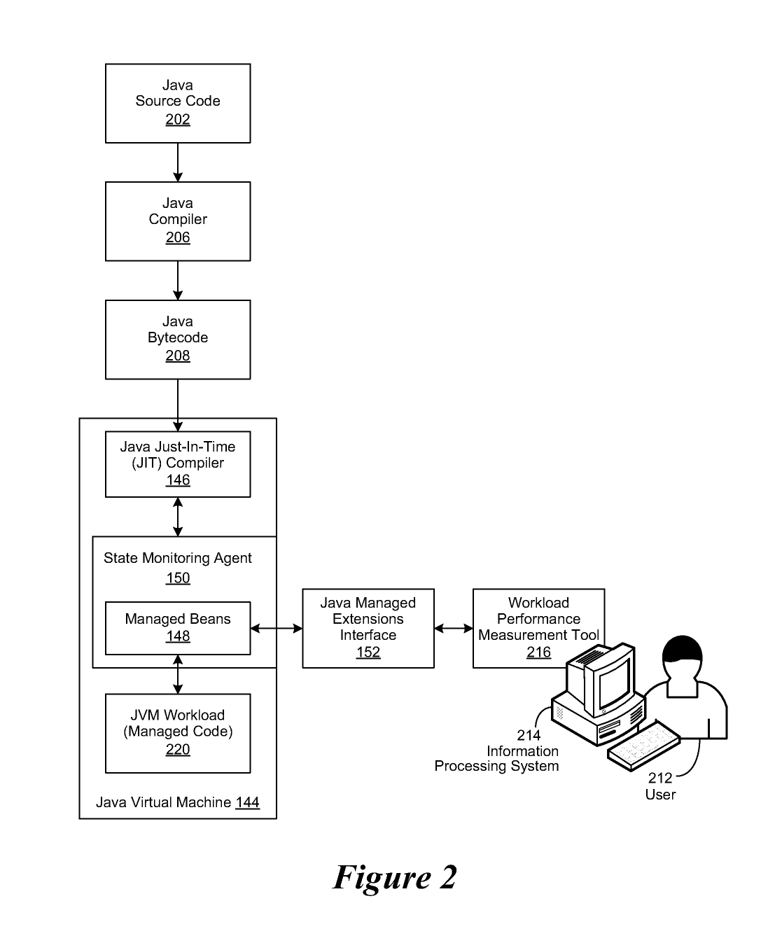

FIG. 2 is a simplified block diagram of a state monitoring agent, Managed Beans (MBeans), and a Java Management Extensions (JMX) interface as implemented in accordance with an embodiment of the invention. In various embodiments, Java source code 202 is compiled by a Java compiler 206 to produce Java bytecode 208. Java compilation operations are then begun by compiling the Java bytecode 208 into a Java virtual machine (JVM) workload 220 with a just-in-time (JIT) compiler 146. In various embodiments, the workload 220 comprises managed code running on the Java virtual machine 144.

In various embodiments, the execution of the JVM workload 220 is monitored with a state monitoring agent 150. In these and other embodiments, the state monitoring agent 150 receives performance measurement data associated with the JVM 144 executing the JVM workload 220. In various embodiments, the performance measurement data comprises class loading data, bytecode interpreter calls data, just-in-time compilation data, garbage collection data, and cache miss data. In these and other embodiments, the performance measurement data is provided to the state monitoring agent 150 by one or more Managed Beans (MBeans) 148. As an example, one or more MBeans 148 may read internal JVM software counters that keep track of statistics such as the rate of just-in-time compilations, calls to the bytecode interpreter, garbage collections, and class loading events. The state monitoring agent 150 then processes the performance measurement data to determine when individual performance measurement data values have remained beneath a predetermined performance threshold value for a predetermined time period. In various embodiments, the predetermined performance threshold value and the predetermined time period are configurable by a user 212.

Once the individual performance measurement data values remain beneath a predetermined performance threshold value for a predetermined time period, the state monitoring agent 150 generates steady-state data. The steady-state data is then provided through an application program interface (API). In various embodiments, the (API) comprises a Java Managed Extensions (JMX) interface 152. In turn, the API provides the steady-state data to a workload performance measurement tool 216 implemented on an information processing system 214 associated with user 212.

It will be apparent to killed practitioners of the art that the present invention may be used to expose many kinds of state information (i.e., in addition to, or in place of, steady-state) that would be useful for performance analysis. For example, the invention can signal changes in hardware event counts that impact performance (e.g., cache misses, branch mispredictions). It can also be used to signal changes in power consumption or heat dissipation, which would be especially useful in the case of server workloads. Even simple information, such as the information that a virtual machine has loaded a particular class, can be communicated. It will likewise be appreciated that such information would be difficult to extract manually, without changes to the virtual machine workload or managed code.

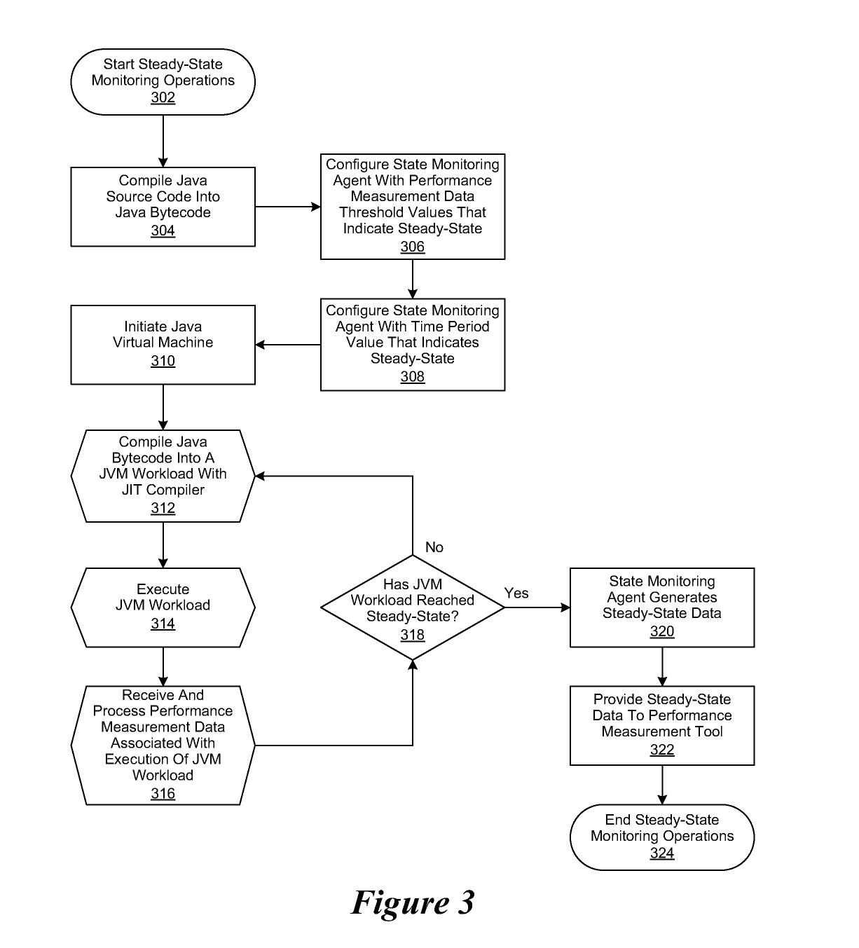

FIG. 3 is a generalized flow chart of the operation of a state monitoring agent as implemented in accordance with an embodiment of the invention. In this embodiment, steady-state monitoring operations are begun in block 302 followed by the compilation of Java source code into Java bytecode in step 304. Then in step 306, the state monitoring agent is configured with performance measurement data threshold values that indicate a target workload has reached a predetermined state, such as a quiescent or steady-state.

In step 308, the state monitoring agent is configured with a time period value, which in conjunction with the aforementioned performance measurement data threshold values, likewise indicate a target workload reaching a predetermined state, such as a steady state. A Java virtual machine (JVM) is then initiated in step 310, followed by the Java bytecode being compiled into a JVM workload with a just-in-time (JIT) compiler in step 312. The JVM workload is then executed in step 314. Performance measurement data is then received and processed by the state monitoring agent in step 316 to determine whether individual performance measurement data values have remained below their respective predetermined performance threshold value for the predetermined time period. If so, then the JVM workload is determined to be in a steady-state. Otherwise, it is not. A determination is then made in step 318 whether the JVM workload has reached a steady-state. If not, the process is continued, proceeding with step 312. Otherwise, the state monitoring agent generates steady-state data in step 320 and then provides it to a performance measurement tool in step 322. Steady-state monitoring operations are then ended in step 324.

It should be understood that at least some aspects of the present invention may alternatively be implemented in a computer-useable medium that contains a program product. Further, it is understood that the present invention may be implemented by a system having means in the form of hardware, software, or a combination of software and hardware as described herein or their equivalent.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for monitoring the state of a workload, comprising:
an agent comprising processing logic operable to:
receive performance measurement data associated with a virtual machine executing managed code; and,
process the performance measurement data to generate predetermined state data when individual performance measurement data values remain below a predetermined performance threshold value for a predetermined time period.

2. The system of claim 1, wherein the virtual machine comprises a Java Virtual Machine.

3. The system of claim 1, wherein the performance measurement data is provided to said agent by a resource manager.

4. The system of claim 1, wherein the predetermined performance threshold and the predetermined time are configurable by a user.

5. The system of claim 1, wherein the predetermined state data is provided to a performance measurement tool.

6. The system of claim 1, wherein the performance measurement data comprises at least one of class loading data, bytecode interpreter calls data, just-in-time (JIT) compilation data, garbage collection data and cache miss data.

7. The system of claim 1, wherein the agent further comprises processing logic to:
provide the predetermined state data through an application program interface.

8. A computer-implemented method for monitoring the state of a workload, comprising:
receiving performance measurement data associated with a virtual machine executing managed code; and,
processing the performance measurement data to generate predetermined state data when individual performance measurement data values remain below a predetermined performance threshold value for a predetermined time period.

9. The method of claim 8, wherein the virtual machine comprises a Java Virtual Machine.

10. The method of claim 8, wherein the performance measurement data is provided to said agent by a resource manager.

11. The method of claim 8, wherein the predetermined performance threshold and the predetermined time are configurable by a user.

12. The method of claim 8, wherein the predetermined state data is provided to a performance measurement tool.

13. The method of claim 8, wherein the performance measurement data comprises at least one of class loading data, bytecode interpreter calls data, just-in-time (JIT) compilation data, garbage collection data and cache miss data.

14. The system of claim 8, further comprising:
providing the predetermined state data through an application program interface.

15. A computer-readable medium embodying computer program code, the computer program code comprising computer executable instructions configured for:
receiving performance measurement data associated with a virtual machine executing managed code; and,
processing the performance measurement data to generate predetermined state data when individual performance measurement data values remain below a predetermined performance threshold value for a predetermined time period.

16. The computer-readable medium of claim 15, wherein the virtual machine comprises a Java Virtual Machine.

17. The computer-readable medium of claim 15, wherein the performance measurement data is provided to said agent by a resource manager.

18. The computer-readable medium of claim 15, wherein the predetermined performance threshold and the predetermined time are configurable by a user.

19. The computer-readable medium of claim 15, wherein the predetermined state data is provided to a performance measurement tool.

20. The computer readable medium of claim 15, wherein the performance measurement data comprises at least one of class loading data, bytecode interpreter calls data, just-in-time (JIT) compilation data, garbage collection data and cache miss data.

21. The computer readable medium of claim 15, further comprising instructions for:
providing the predetermined state data through an application program interface.
